(19) United States
(12) Patent Application Publication
(10) Pub. No.: US 2012/0103731 A1
(43) Pub. Date: May 3, 2012

(54) VIBRATION DAMPING DEVICE FOR ELEVATOR

(75) Inventor: Yoichi Sakuma, Tokyo (JP)

(73) Assignee: MITSUBISHI ELECTRIC CORPORATION, Tokyo (JP)

(21) Appl. No.: 13/382,320

(22) PCT Filed: Aug. 19, 2009
(86) PCT No.: PCT/JP09/64526

§ 371 Date: Jan. 5, 2012

(51) Int. Cl. B66B 1/34

(52) U.S. Cl. 187/292

(57) ABSTRACT

A vibration damping device for suppressing transverse vibrations occurring in an elevating body of an elevator is configured so that a coil provided on the actuator moving part side can be held firmly to a bobbin, and a minute slippage occurring in the coil can be prevented reliably.

For this purpose, a groove is formed in the wire direction of the coil in the bobbin of the moving part, and the coil is formed by winding the wire in the groove. The coil is integrated as a whole, and the adjacent wires forming the innermost layer of the coil are brought into contact with each other, and are brought into contact with a part of the groove in the transverse cross section.

### TECHNICAL FIELD

The present invention relates to a vibration damping device for suppressing transverse vibrations occurring in an elevating body of an elevator.

### BACKGROUND ART

An elevating body of an elevator, for example, a car in which an elevator user gets moves up and down in a shaft along a guide rail erected in the shaft. That is, on the car of the elevator, a guiding device provided with a roller or the like is installed, and the roller rolls along the guide face of the guide rail, whereby the horizontal movement of car is restrained within a predetermined range.

Therefore, if the guide rail itself is bent slightly, or if a local and minute bend is present at a joint of the guide rails, transverse vibrations occur in the car when the roller passes through the bended portion of the guide rail. Such a phenomenon is more remarkable as the travel speed of the car increases, and especially for a high-speed elevator, this phenomenon is a major cause for the hindrance to the comfort in the car.

Conventionally, an attempt has been made to reduce the transverse vibrations occurring in the car by the optimal design of an elevator system or passive vibration damping.

Also, to reduce the transverse vibrations, a technique of active vibration damping described in Patent Literature 1 has been contrived. Specifically, in the vibration damping device described in Patent Literature 1, the vibrating state of the car is detected by using a sensor, and thereby an actuator is operated according to the detection result, whereby the vibrations of the car are suppressed actively.

### CITATION LIST

### Patent Literature

Patent Literature 1: Japanese Patent Laid-Open No. 2001-122555

### SUMMARY OF INVENTION

### Technical Problem

The vibration damping device described in Patent Literature 1 is configured so that the pressing force of a roller against a guide rail is controlled by moving an actuator moving part of the vibration damping device up and down, whereby the vibrations of a car is suppressed.

FIG. 22 is a sectional view of an essential part of the conventional vibration damping device for an elevator, showing the details of an actuator used for the vibration damping device. In FIG. 22, reference numeral 31 denotes a bobbin provided on the actuator moving part side, 32 denotes a coil wound on the bobbin 31, and 33 denotes a wire forming the coil 32. When the coil 32 is manufactured, it is difficult to continuously wind the wire 33 so as to be in close contact with flanges 34 on both sides of the bobbin 31. Generally, a small gap 35 is formed between the coil 32 and one flange 34 (or both flanges 34).

When an inertial force is applied to the coil 32 by the movement of the moving part, a minute slippage may occur in the coil 32 to the direction in which the gap 35 is formed. If the slight movement of the coil 32 is repeated by the reciprocating motion of the moving part, there may arise such a problem that the insulating layer formed on the wire 33 may wear away.

The present invention was made to solve the above-described problem, and an object of the invention is to provide a vibration damping device for an elevator for suppressing transverse vibrations occurring in an elevating body of the elevator, which device can firmly holding a coil provided on the actuator moving part side to a bobbin, and can reliably prevent the minute slippage occurring in the coil.

### Solution to Problem

A vibration damping device for an elevator of the invention is a vibration damping device for an elevator, which is used for suppressing transverse vibrations occurring in an elevating body of the elevator. The vibration damping device comprises a stationary part having a permanent magnet, which is provided on the elevating body, a moving part which has a coil wound on a bobbin, and is moved within a predetermined range by the Lorentz force generated when the coil is energized, and a controller which carries a current in the coil according to the transverse vibrations occurring in the elevating body and operates the moving part to reduce the transverse vibrations occurring in the elevating body. The bobbin is provided with a groove extending in the wire direction of the coil in a winding surface on which the coil is wound. The coil is integrated as a whole, and the adjacent wires forming the innermost layer of the coil are in contact with each other, and are in contact with a part of the groove in the transverse cross section.

### Advantageous Effects of Invention

According to the present invention, in a vibration damping device for suppressing transverse vibrations occurring in an elevating body of the elevator, a coil provided on the actuator moving part side can be held firmly to a bobbin, and the minute slippage occurring in the coil can be prevented reliably.

### BRIEF DESCRIPTION OF DRAWINGS

FIG. 1 is a front view of an elevator car provided with a vibration damping device in a first embodiment according to the present invention.

FIG. 2 is a view taken along the line A-A of FIG. 1.

FIG. 3 is a view showing the details of a guiding device shown in FIG. 1.

FIG. 4 is a view taken along the line B-B of FIG. 3.

FIG. 5 is a view taken along the line C-C of FIG. 3.

FIG. 6 is a front view showing an actuator moving part of the vibration damping device in the first embodiment according to the present invention.

FIG. 7 is a sectional view showing the moving part of the vibration damping device in the first embodiment according to the present invention.

FIG. 8 is a front view showing a general configuration of a bobbin.

FIG. 9 is a front view showing another general configuration of the bobbin.

FIG. 10 is a view showing the details of portion D of FIG. 7.

FIG. 11 is a view for explaining the details of the bobbin in the first embodiment according to the present invention.

FIG. 12 is a detail view of portion D in a second embodiment according to the present invention.

FIG. 13 is a view for explaining the details of the bobbin in the second embodiment according to the present invention.

FIG. 14 is a detail view of portion D in a third embodiment according to the present invention.

FIG. 15 is a view for explaining the details of the bobbin in the third embodiment according to the present invention.

FIG. 16 is a detail view of portion D in a fourth embodiment according to the present invention.

FIG. 17 is a view for explaining the details of the bobbin in the fourth embodiment according to the present invention.

FIG. 18 is a detail view of portion D in a fifth embodiment according to the present invention.

FIG. 19 is a view for explaining the details of the bobbin in the fifth embodiment according to the present invention.

FIG. 20 is a detail view of portion D in a sixth embodiment according to the present invention.

FIG. 21 is a view for explaining the details of the bobbin in the sixth embodiment according to the present invention.

FIG. 22 is a sectional view of an essential part of the conventional vibration damping device for an elevator.

### DESCRIPTION OF EMBODIMENTS

The present invention will be described in more detail with reference to the accompanying drawings. Incidentally, in each of the drawings, like numerals refer to like or similar parts and redundant descriptions of these parts are appropriately simplified or omitted.

### First Embodiment

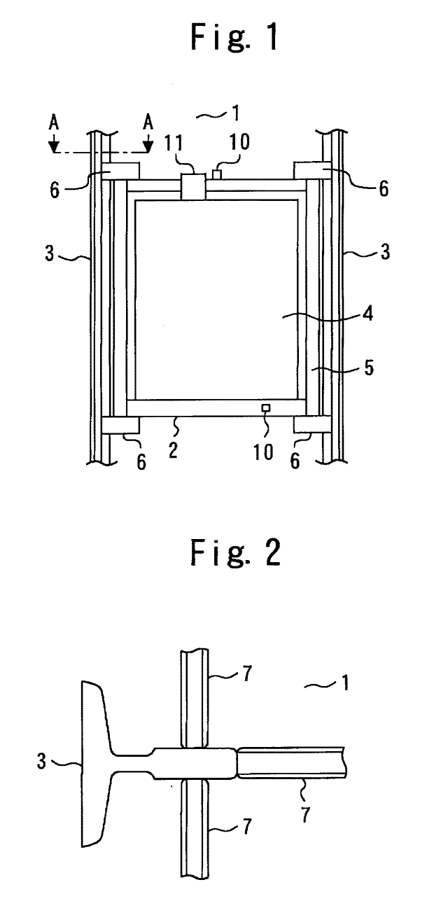

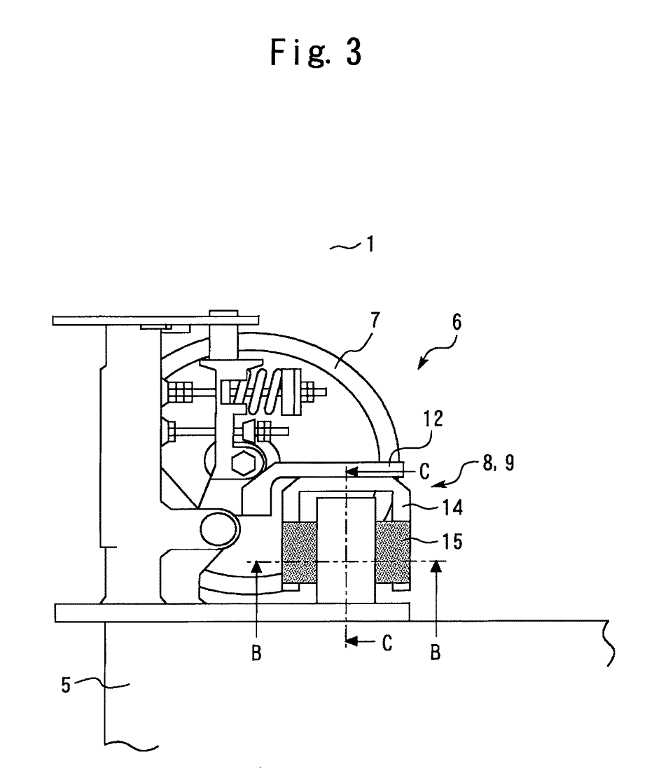

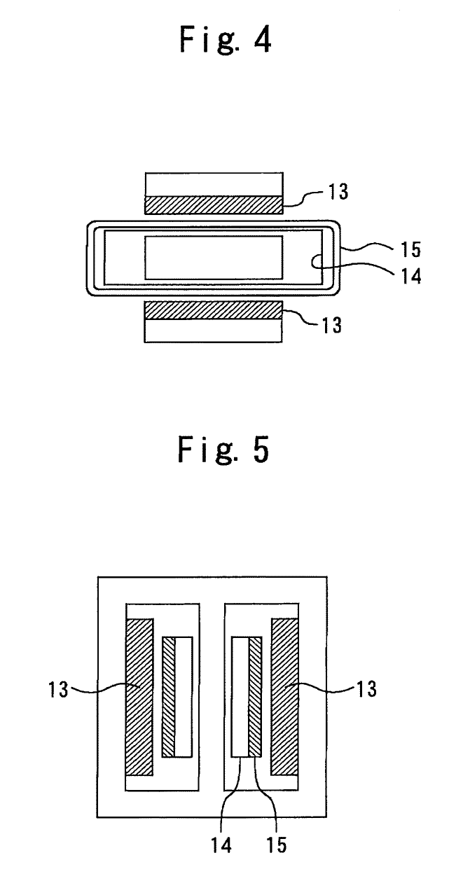

FIG. 1 is a front view of an elevator car provided with a vibration damping device in a first embodiment according to the present invention, FIG. 2 is a view taken along the line A-A of FIG. 1, FIG. 3 is a view showing the details of a guiding device shown in FIG. 1, FIG. 4 is a view taken along the line B-B of FIG. 3, and FIG. 5 is a view taken along the line C-C of FIG. 3.

In FIGS. 1 to 5, reference numeral 1 denotes an elevator shaft, 2 denotes an elevator car moving up and down in the shaft 1, 3 denotes a pair of guide rails erected in the shaft 1.

The car 2 constitutes an elevating body of the elevator, and includes, for example, a car room 4, a car frame 5 for supporting the car room 4 and the like, and guiding devices 6 provided on both sides of the top portion and bottom portion of the car frame 5. The guiding device 6 is used for guiding the up and down movement of the car 2 by engaging with the guide rail 3. This guiding device 6 is provided with rollers 7 that are in contact with the opposed guide rail from three directions. That is, by the rolling of these rollers 7 on the guide surface of the guide rail 3, the horizontal movement of the car 2 is restrained within a predetermined range, and the vertical movement thereof is guided smoothly.

Reference numeral 8 denotes a vibration damping device for suppressing transverse vibrations occurring in the car 2. This vibration damping device 8 detects the transverse vibrations occurring in the car 2, and controls the pressing forces of the rollers 7 against the guide rail 3 so that the occurred transverse vibrations are suppressed. Specifically, the vibration damping device 8 is supported on the car frame 5, and the essential portion thereof is composed of an actuator 9, a sensor 10, and a controller 11.

The actuator 9 includes a stationary part provided on the car frame 5 and a moving part provided on a lever 12 moving in association with the roller 7.

The stationary part of the actuator 9 has a permanent magnet 13. This permanent magnet 13 is fixed to the car frame 5 via a predetermined supporting member or the like.

The moving part of the actuator 9 has a bobbin 14 fixed to the lever 12 and a coil 15 wound on this bobbin 14, and the coil 15 is arranged so as to be influenced by the magnetic field of the permanent magnet 13. Therefore, when the coil 15 is energized, the Lorentz force corresponding to the direction and magnitude of the current is generated in the coil 15. The moving part is moved up and down by this generated Lorentz force, so that the lever 12 is oscillated. The range in which the moving part can move is set to a predetermined range.

The controller 11 has a function of carrying a current in the coil 15 according to the transverse vibrations occurring in the car 2 and operating the moving part of the actuator 9 to reduce the transverse vibrations. The sensor 10 is used for detecting the transverse vibrations occurring in the car 2. That is, the controller 11 determines the value of the current carried in the coil 15 based on the detection signal of the sensor 10, and gives an operation command to the actuator 9.

In the vibration damping device 8 having the above-described configuration, each time vibration damping control is carried out (that is, the moving part moves), an inertial force is applied to the coil 15. Therefore, the moving part of the actuator 9 of the first embodiment is provided with a peculiar mechanism for preventing a minute slippage in the coil 15 from occurring even when the inertial force is applied.

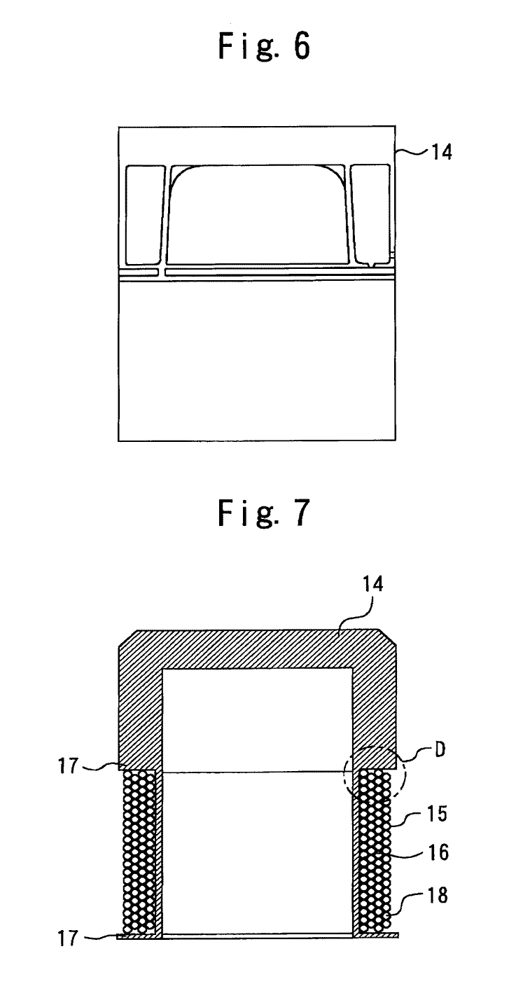

Hereinafter, the configuration of the moving part of the actuator 9 is explained in detail with reference to FIGS. 6 to 11.

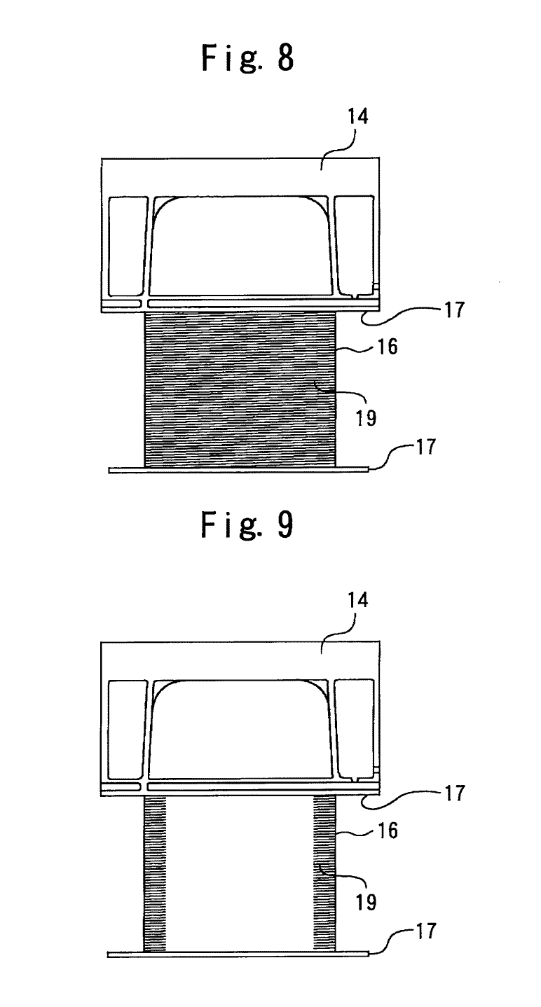

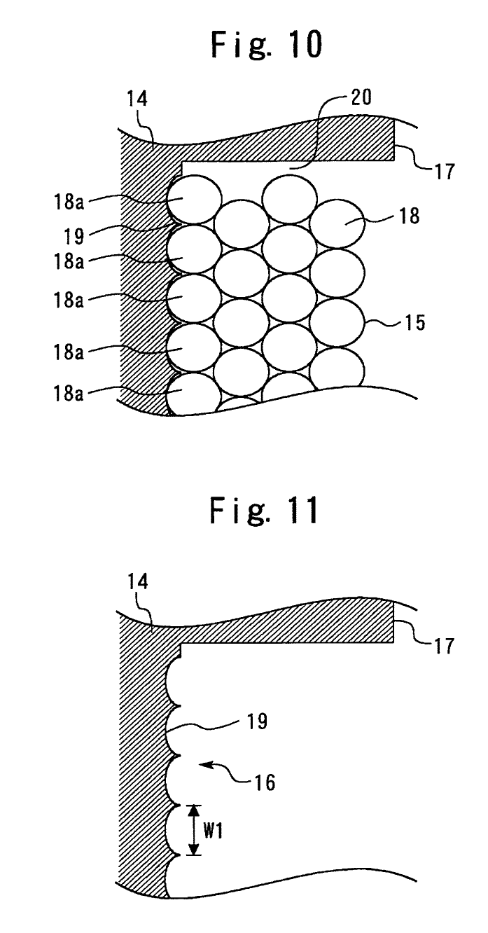

FIG. 6 is a front view showing the moving part of the vibration damping device in the first embodiment according to the present invention, FIG. 7 is a sectional view showing the moving part of the vibration damping device in the first embodiment according to the present invention, FIG. 8 is a front view showing a general configuration of the bobbin, FIG. 9 is a front view showing another general configuration of the bobbin, FIG. 10 is a view showing the details of portion D of FIG. 7, and FIG. 11 is a view for explaining the details of the bobbin in the first embodiment according to the present invention. The portion shown in FIG. 11 corresponds to portion D of FIG. 7, showing the state before the coil 15 is wound.

In FIGS. 6 to 11, reference numeral 16 denotes a winding surface formed on the bobbin 14, 17 denotes flanges of the bobbin 14 that are arranged on both sides (on the upside and downside in FIG. 7) of the winding surface 16, and 18 denotes a wire forming the coil 15. In the winding surface 16 of the bobbin 14, a groove 19 corresponding to the wire diameter of the wire 18 is formed so as to be equally spaced in the direction in which the wire 18 is wound.

The location in which the groove 19 is formed may be the whole region of a portion in which the wire 18 is wound (refer to FIG. 8) in the winding surface 16, or may be only corner portions (curved portions) (refer to FIG. 9) in the winding surface 16. Also, the method for forming the groove 19 in the winding surface 16 is not subject to any special restriction. For example, the groove 19 may be formed by machining the bobbin 14, or the bobbin 14 may be manufactured by integrally molding a body part and a groove part.

Specifically, in the transverse cross section (the cross section intersecting at right angles with the lengthwise direction of the groove 19), the groove 19 formed in the winding surface 16 has a curved shape forming a part of a circle. Also, this groove 19 has an opening width (W1 in FIG. 11) equal to the wire diameter of the wire 18, and has a curve greater than that of the wire 18 (a smaller curvature) in the transverse cross section.

Since the groove 19 has the above-described shape, the wire 18 wound in the groove 19, that is, a wire 18a forming the innermost layer of the coil 15 does not come into contact with the whole of the groove 19, but comes into contact with the deepest portion only of the groove 19 in the transverse cross section (the cross section intersecting at right angles with the lengthwise direction of the wire 18). Also, since the space between the grooves 19 is formed so as to match the wire diameter of the wire 18, the adjacent wires 18a forming the innermost layer come into contact with each other throughout the lengthwise portion.

As described in the conventional example, a small gap 20 is formed between the coil 15 and the one flange 17 of the bobbin 14 (or both the flanges 17). Therefore, when the inertial force is applied to the coil 15 by the movement of the moving part, if the inertial force is larger than the holding force for the coil 15, a minute slippage occurs in the coil 15.

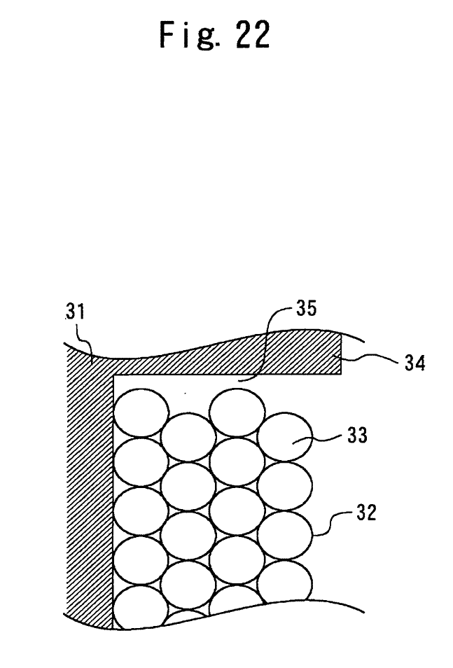

In the conventional configuration shown in FIG. 22, the tension applied when the wire 33 is wound on the winding surface and the frictional force defined by the friction coefficient between the wire 33 and the winding surface correspond to the holding force.

On the other hand, for the moving part in this embodiment, in addition to the frictional force between the wire 18a and the winding surface 16, the resistance force at the time when the wire 18a gets over the edge of the groove 19 can also be utilized as the holding force. Also, in order to get over the edge of the groove 19, the wire 18a must move to the side while rotating with the lengthwise direction thereof being an axis direction. For the coil 15, since the wire 18a is in contact with the adjacent wire 18a, the frictional resistance between the wires 18a can also be utilized as the holding force.

In the moving part, after the wire 18 has been wound on the winding surface 16, the whole of the coil 15 keeps being integrated by impregnating the coil 15 with varnish or by using a self-welding wire as the wire 18 and curing the wire 18 by heat. Thereby, the adhesive force between the wires 18a can be utilized as the holding force, and the minute slippage occurring in the coil 15 can be prevented reliably.

According to the first embodiment of the present invention, in the vibration damping device 8 for suppressing transverse vibrations occurring in the elevator car 2, the coil 15 provided on the moving part side of the actuator 9 can be held firmly on bobbin 14, and the minute slippage occurring in the coil 15 can be prevented reliably.

FIGS. 7 and 10 show the case where the wire 18 is wound on the winding surface 16 by complete aligned winding. However, it is a matter of course that even if disorder occurs partially in the outside layer portion of the coil 15, the above-described effects can be anticipated.

### Second Embodiment

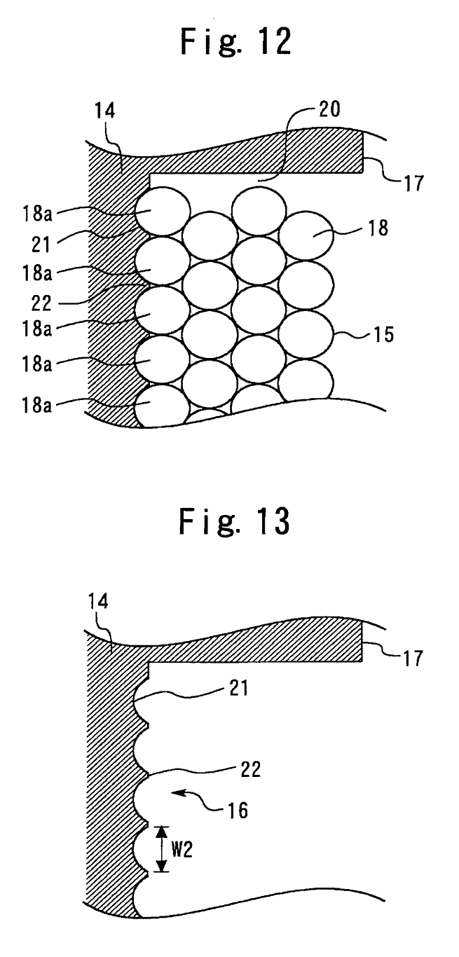

FIG. 12 is a detail view of portion D in a second embodiment according to the present invention, and FIG. 13 is a view for explaining the details of the bobbin in the second embodiment according to the present invention.

In FIGS. 12 and 13, in the winding surface 16 of the bobbin 14, a groove 21 corresponding to the wire diameter of the wire 18 is formed so as to be equally spaced in the direction in which the wire 18 is wound. The groove 21, like the groove 19, has a curved shape forming a part of a circle in the transverse cross section. Also, the groove 21 has an opening width (W2 in FIG. 13) narrower than the wire diameter of the wire 18, and has a curve greater than that of the wire 18 in the transverse cross section.

In the first embodiment, the space between the grooves 19 is equal to the opening width W1. On the other hand, in the second embodiment, the space between the grooves 21 is set so as to be larger than the opening width W2. Therefore, between the adjacent grooves 21, a flat part 22 is formed along the lengthwise direction of the groove 21.

In the case where the groove 19 is formed in the winding surface 16 by machining in the first embodiment, in the edge portion (boundary portion) of the groove 19, burrs are liable to be produced by cutting resistance, and the burrs may damage the wire 18a. On the other hand, in the second embodiment, since the flat part 22 is formed between the adjacent grooves 21, even in the case where the groove 21 is formed by machining, the burrs produced in the edge portion of the groove 21 can be reduced significantly. Also, since the flat part 22 is formed, finish machining such as removing of sharp edge becomes easy. Therefore, the damage to the wire 18a can be reduced significantly.

Other configurations are the same as those of the first embodiment.

### Third Embodiment

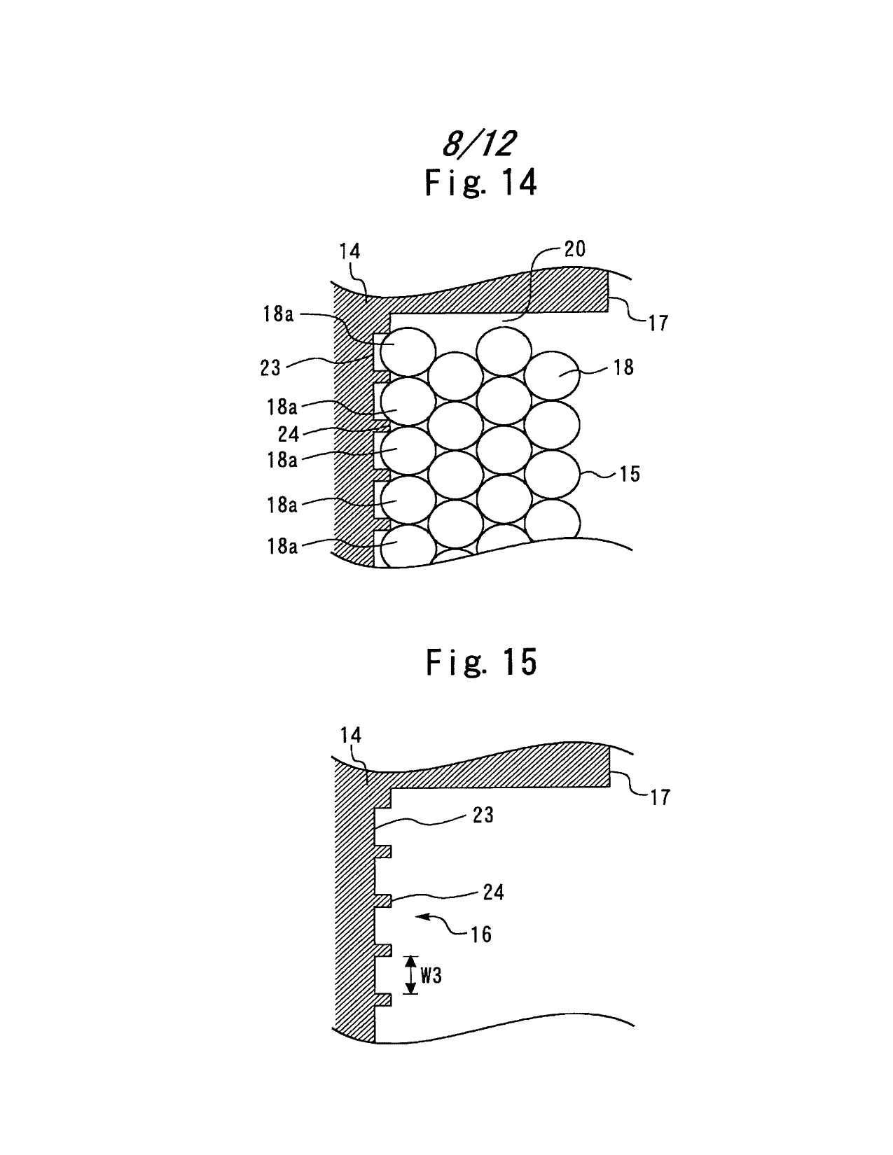

FIG. 14 is a detail view of portion D in a third embodiment according to the present invention, and FIG. 15 is a view for explaining the details of the bobbin in the third embodiment according to the present invention.

In FIGS. 14 and 15, in the winding surface 16 of the bobbin 14, a groove 23 corresponding to the wire diameter of the wire 18 is formed so as to be equally spaced in the direction in which the wire 18 is wound. The groove 23 has a rectangular shape having a width (W3 in FIG. 15) narrower than the wire diameter of the wire 18 in the transverse cross section. Since the groove 23 has the rectangular shape, between the adjacent grooves 23, a flat part 24 is naturally formed along the lengthwise direction of the groove 23.

Since the groove 23 has the above-described shape, the wire 18a forming the innermost layer of the coil 15 is fixed to the bobbin 14 in the state of being in contact with both edge portions (boundary portions between the groove 23 and the flat part 24) of the groove 23 throughout the lengthwise portion. Also, since the space between the grooves 23 is formed so as to match the wire diameter of the wire 18, the adjacent wires 18a forming the innermost layer come into contact with each other throughout the lengthwise portion.

In the first and second embodiments, the wire 18a forming the innermost layer is in contact with the groove 19 and 21, respectively, at one place in the transverse cross section. On the other hand, in the third embodiment, the wire 18a is in contact with the groove 23 at two places separate in the up and down direction in the transverse cross section. Since the bobbin 14 (moving part) is moved reciprocatingly in the up and down direction by vibration damping control, an upward inertial force and a downward inertial force in FIG. 14 are applied to the coil 15. If the groove 23 is configured as described above, the support of the wire 18a matching the direction in which the inertial force acts, that is, the support at two places in the up and down direction becomes enabled, so that the coil 15 can be held on the bobbin 14 more firmly.

To prevent the damage to the wire 18a wound in the groove 23, it is preferable that both the edge portions of the groove 23 be subjected to finishing treatment such as chamfering or removing of sharp edge.

Other configurations are the same as those of the first embodiment.

### Fourth Embodiment

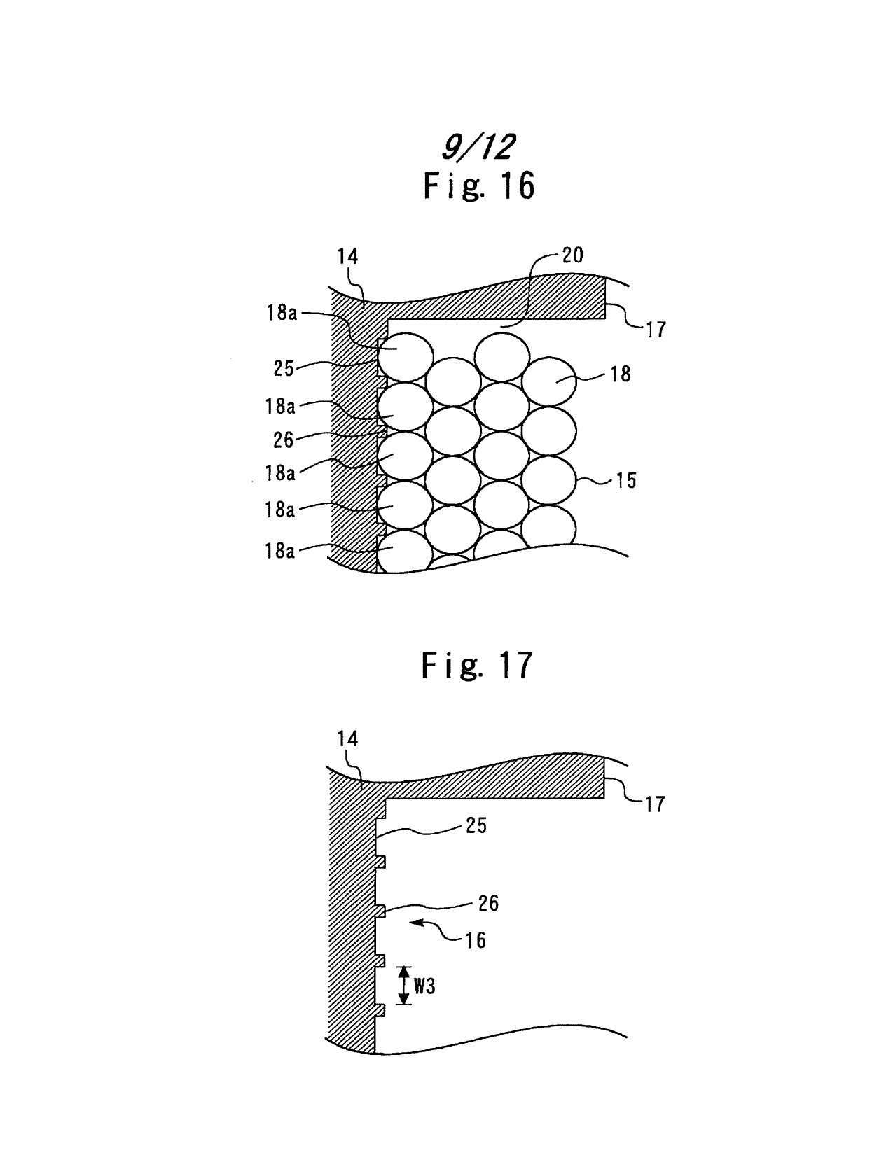

FIG. 16 is a detail view of portion D in a fourth embodiment according to the present invention, and FIG. 17 is a view for explaining the details of the bobbin in the fourth embodiment according to the present invention.

In FIGS. 16 and 17, in the winding surface 16 of the bobbin 14, a groove 25 corresponding to the wire diameter of the wire 18 is formed so as to be equally spaced in the direction in which the wire 18 is wound. The groove 25 has the same configuration as that of the groove 23 except that the depth of the groove 25 is shallower than that of the groove 23. Also, reference numeral 26 denotes a flat part formed between the adjacent grooves 25.

Since the groove 25 has the above-described shape, the wire 18a forming the innermost layer of the coil 15 is fixed to the bobbin 14 in the state of being in contact with both edge portions and the bottom surface of the groove 25 throughout the lengthwise portion. Also, since the space between the grooves 25 is formed so as to match the wire diameter of the wire 18, the adjacent wires 18a forming the innermost layer come into contact with each other throughout the lengthwise portion.

In the third embodiment, the wire 18a forming the innermost layer is supported on the corresponding groove 23 at two places in the up and down direction in the transverse cross section. On the other hand, in the fourth embodiment, the wire 18a is in contact with the groove 25 at three places separate in the up and down direction in the transverse cross section. Therefore, if the groove 25 is configured as described above, the loads acting on the wire 18a (for example, the tension at the winding time and the above-described inertial force) can be distributed, so that the loads can be prevented from concentrating locally on the wire 18a.

Other configurations are the same as those of the third embodiment.

### Fifth Embodiment

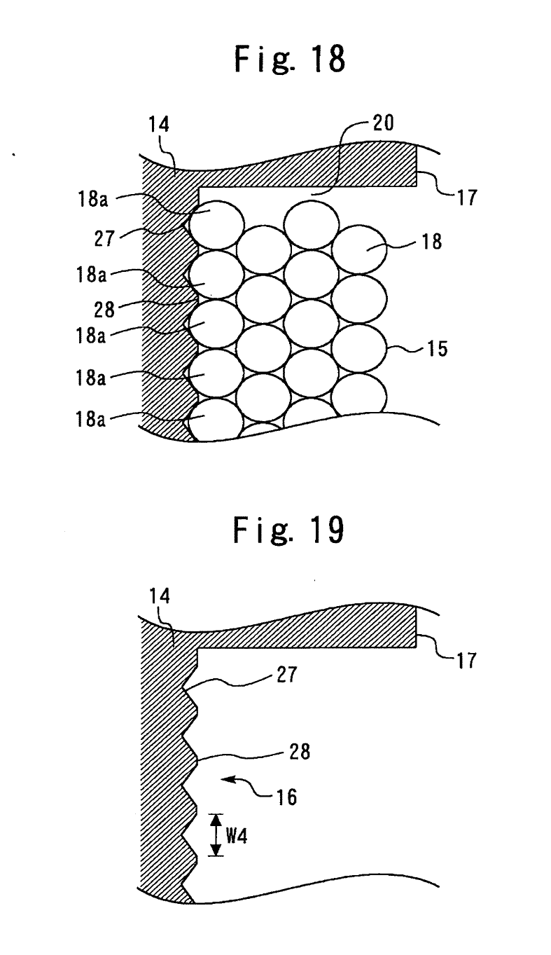

FIG. 18 is a detail view of portion D in a fifth embodiment according to the present invention, and FIG. 19 is a view for explaining the details of the bobbin in the fifth embodiment according to the present invention.

In FIGS. 18 and 19, in the winding surface 16 of the bobbin 14, a groove 27 corresponding to the wire diameter of the wire 18 is formed so as to be equally spaced in the direction in which the wire 18 is wound. The groove 27 has a wedge shape (triangular shape) having an opening width (W4 in FIG. 19) narrower than the wire diameter of the wire 18 in the transverse cross section. Also, between the grooves 27, a flat part 28 is formed along the lengthwise direction of the groove 27.

Since the groove 27 has the above-described shape, the wire 18a forming the innermost layer of the coil 15 is fixed in the state of being in contact with both of two inclined surfaces forming the groove 27 throughout the lengthwise portion. Also, since the space between the grooves 27 is formed so as to match the wire diameter of the wire 18, the adjacent wires 18a forming the innermost layer come into contact with each other throughout the lengthwise portion.

In the third embodiment, since the wire 18a forming the innermost layer is supported by both edge portions of the groove 23, the loads acting on the wire 18a concentrate locally on the wire 18a. On the other hand, in the fifth embodiment, since the wire 18a is supported by the inclined surfaces, that is, by planes, the loads acting on the wire 18a can be distributed. Also, if the groove 27 is configured as described above, the wire 18a can be held firmly by the wedge effect.

The flat part 28 between the grooves 27 may be formed as necessary, and the grooves 27 may be formed continuously in the up and down direction (width direction) like the grooves 19 in the first embodiment.

Other configurations are the same as those of the third embodiment.

### Sixth Embodiment

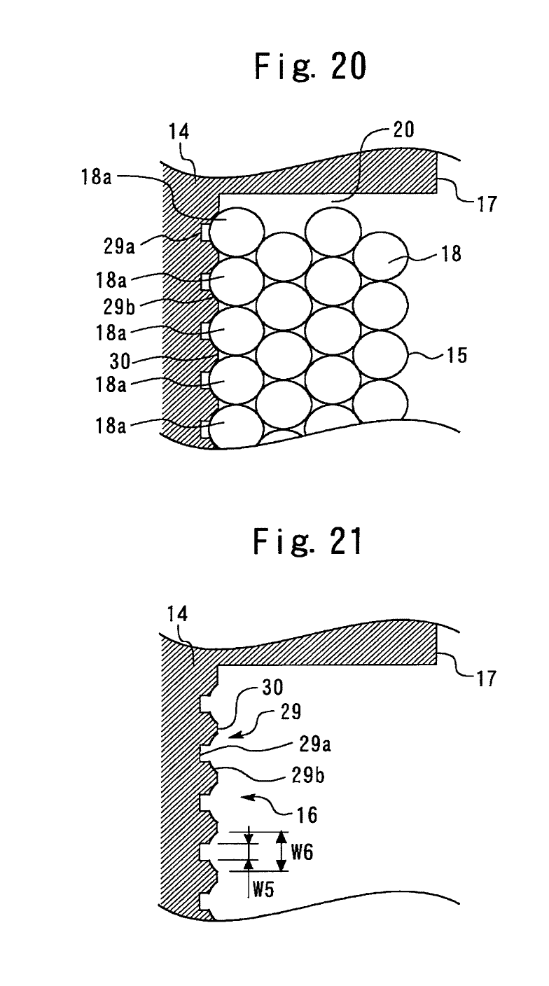

FIG. 20 is a detail view of portion D in a sixth embodiment according to the present invention, and FIG. 21 is a view for explaining the details of the bobbin in the sixth embodiment according to the present invention.

In FIGS. 20 and 21, in the winding surface 16 of the bobbin 14, a groove 29 corresponding to the wire diameter of the wire 18 is formed so as to be equally spaced in the direction in which the wire 18 is wound. The groove 29 has an upper and lower two-stage construction consisting of a lower groove 29a and an upper groove 29b. Specifically, the lower groove 29a has a rectangular shape in the transverse cross section, and has a width (W5 in FIG. 21) narrower than the wire diameter of the wire 18. Also, the upper groove 29b is formed by curved surfaces spreading to the outside and upside (the winding surface 16 side) from both the edge portions of the lower groove 29a, and has an opening width (W6 (>W5) in FIG. 21) wider than the width of the lower groove 29a and narrower than the wire diameter of the wire 18. The upper groove 29b is configured so as to form a part of a circle in the transverse cross section and to have a curve greater than the wire 18. Reference numeral 30 denotes a flat part formed between the adjacent grooves 29.

That is to say, the groove 29 corresponds to a groove formed by adding a rectangular groove to the deepest portion of the groove 21 of the second embodiment.

Since the groove 29 has the above-described shape, the wire 18a forming the innermost layer of the coil 15 is fixed to the bobbin 14 in the state of being in contact with both the edge portions of the lower groove 29a (the boundary portions between the lower groove 29a and the upper groove 29b) throughout the lengthwise portion. Also, since the space between the grooves 29 is formed so as to match the wire diameter of the wire 18, the adjacent wires 18a forming the innermost layer come into contact with each other throughout the lengthwise portion.

For the groove 23 (and 25) in the third (and fourth) embodiment, if the width W3 of the groove 23 becomes too narrow with respect to the wire diameter of the wire 18, the wire 18 becomes liable to be removed from the groove 23 when the wire 18 is wound on the winding surface 16, so that it becomes difficult to arrange the wire 18 in good order. On the other hand, in the sixth embodiment, since the groove 29 has the upper and lower two-stage construction, and the wire 18a is supported on both the edge portions of the lower groove 29a, when the wire 18 is wound, the upper groove 29b can be caused to function as a guide for the wire 18, so that the above-described problem can be solved. Also, if the configuration is such as to be described above, the resistance force at the time when the wire 18a gets over the upper groove 29b can also be utilized as the holding force for the coil 15.

Other configurations are the same as those of the third embodiment.

In the above-described embodiments, explanation has been given of a voice coil type actuator applied to an active roller guide, as described in Patent Literature 1. However, this merely shows one example. It is a matter of course that an actuator of any type in which a coil is provided on the moving part side of the actuator for the vibration damping device having the above-described functions can achieve the same effects as described above if having the same configuration as described above.

### INDUSTRIAL APPLICABILITY

The vibration damping device for an elevator according to the present invention can apply to the vibration damping device which suppresses transverse vibrations occurring in an elevating body of elevator and has a coil on the actuator moving part side of an actuator.

### Reference Signs List

1 shaft

2 car

3 guide rail

4 car room

5 car frame

6 guiding device

7 roller

8 vibration damping device

9 actuator

10 sensor

11 controller

12 lever

13 permanent magnet

14, 31 bobbin

15, 32 coil

16 winding surface

17, 34 flange

18, 18a, 33 wire

19, 21, 23, 25, 27, 29 groove

20, 35 gap

22, 24, 26, 28, 30 flat part

29a lower groove

26b upper groove

1. A vibration damping device for an elevator, which is used for suppressing transverse vibrations occurring in an elevating body of the elevator, comprising:
a stationary part having a permanent magnet, which is provided on the elevating body;
a moving part which has a coil wound on a bobbin, and is moved within a predetermined range by the Lorentz force generated when the coil is energized; and
a controller which carries a current in the coil according to the transverse vibrations occurring in the elevating body and operates the moving part to reduce the transverse vibrations occurring in the elevating body, wherein
the bobbin is provided with a groove extending in the wire direction of the coil in a winding surface on which the coil is wound, and
the coil is integrated as a whole, and the adjacent wires forming the innermost layer of the coil are in contact with each other, and are in contact with a part of the groove in the transverse cross section.

2. The vibration damping device for an elevator according to claim 1, wherein
the wire forming the innermost layer of the coil is in contact with the groove at a plurality of separate places in the transverse cross section.

3. The vibration damping device for an elevator according to claim 2, wherein
the groove formed in the winding surface of the bobbin has a rectangular shape having a width narrower than the wire diameter of the wire of the coil, and
the wire forming the innermost layer of the coil is in contact with both the edge portions of the groove.

4. The vibration damping device for an elevator according to claim 3, wherein
the wire forming the innermost layer of the coil is in contact with both the edge portions of the groove and the bottom surface of the groove.

5. The vibration damping device for an elevator according to claim 2, wherein
the groove formed in the winding surface of the bobbin has a wedge shape having an opening width narrower than the wire diameter of the wire of the coil, and
the wire forming the innermost layer of the coil is in contact with both of the inclined surfaces forming the groove.

6. The vibration damping device for an elevator according to claim 2, wherein
the groove formed in the winding surface of the bobbin comprises:
a rectangular lower groove having a width narrower than the wire diameter of the wire of the coil; and
an upper groove which consists of curved surfaces spreading to the outside from both the edge portions of the lower groove, and has an opening width narrower than the wire diameter of the wire of the coil, and
the wire forming the innermost layer of the coil is in contact with both the edge portions of the lower groove.

7. The vibration damping device for an elevator according to claim 1, wherein
the groove formed in the winding surface of the bobbin has a curved shape having an opening width narrower than the wire diameter of the wire of the coil and having a curvature smaller than that of the wire of the coil in the transverse cross section.
